(19) United States
(12) Patent Application Publication
(10) Pub. No.: US 2010/0257131 A1
(43) Pub. Date: Oct. 7, 2010

(54) APPARATUS AND METHOD FOR CONTROLLING HYBRID MOTOR

(76) Inventors: Kun-Oh Kim, Gyeonggi-do (KR); kwang-Sun Choi, Gyeonggi-do (KR); Yong-Il Jeong, Gyeonggi-do (KR); Sang-Bum Ha, Gyeonggi-do (KR); Ho-Jin Lee, Gyeonggi-do (KR)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/298,188

(22) PCT Filed: Dec. 28, 2007
(86) PCT No.: PCT/KR2007/006969

§ 371 Date: Oct. 23, 2008

(51) Int. Cl. G06N 5/02

(52) U.S. Cl. 706/47; 706/52; 706/46

(57) ABSTRACT

The present invention relates to a content recommendation method in which pieces of information collected over an IP Multimedia Subsystem (IMS) network are analyzed through data mining, a semantic pattern is identified from the information and described based on ontology, the characteristics of content to be offered are recorded in ontology and language morphological pattern, and a recommendation filter in terms of various viewpoints and methods is operated in an integrated recommendation framework, thus enabling content recommendation suitable for various contexts to be performed.

The method includes the steps of receiving user information, creating personal preference information based on the user information, deciding a recommendation strategy based on the preference information for content, combining recommendation functions using the recommendation strategy and the content information, personalizing recommendation results with respect to the combination, and providing the personalized content information.

Furthermore, the method for recommending content with context awareness according to the present invention has an advantage in that it can offer more efficient and accurate content to mobile terminal users as a mobile communication network is expanded into an IMS basis and opened and therefore the types and number of content accessible by mobile terminals as well as mobile phones increase abruptly. Furthermore, the method for recommending content with context awareness according to the present invention is advantageous in that it can analogize the life pattern of a mobile terminal user, etc. based on the user's current context information and offers content matching the inferred life pattern at the right time and place.

### TECHNICAL FIELD

The present invention relates to a method for recommending content with context awareness, and more particularly, to a content recommendation method in which pieces of information collected over an IP Multimedia Subsystem (IMS) network are analyzed through data mining, a semantic pattern is identified from the information and described based on ontology, the characteristics of content to be offered are recorded in ontology and language morphological pattern, and a recommendation filter in terms of various viewpoints and methods is operated in an integrated recommendation framework, thus enabling content recommendation suitable for various contexts to be performed.

### BACKGROUND ART

In conventional content recommendation, a method of deciding the propensity of a person is largely classified into recommendation based on propensity decision identified through data mining and recommendation using a define decision tree with respect to each decided context.

Furthermore, with regard to a system that performs personalized recommendation, personalized information is recommended as a precondition for user information disclosure and a terminal condition for the recommendation is presented. Alternatively, in a person-oriented service providing method, respective modules (semantic matching, ontology service, profile management) are configured from separate points of view on the basis of ontology-based semantic matching.

In the case of propensity decision identified through data mining, generally, patterns of associated propensity are analyzed based on a history in which a customer used content in the past, customers are subdivided on the basis of distinct patterns, and customer preference according to the subdivided propensity is found. This method is very effective when a number of customer histories exist and the number of customer histories is sufficient many statistically (when there is statistical discrimination). However, when the number of customer histories is not sufficient many (for example, when the history of new content types is not sufficient many), corresponding recommendation cannot exhibit an adequate effect. Further, in the case in which new and various kinds of contents are continuously created as in an IMS mobile communication environment, there is a possibility that the newly added contents may not fall within the category of recommendation.

Furthermore, preference discriminated through data mining cannot be personalized sufficiently since it is not the propensity of one person, but the propensity of a representative group with a similar propensity.

In the prior art, in the case in which recommendation is performed using a decision tree predefined based on understood customer preference, there is a limit that it may result in inadequate recommendation when the decision tree is not previously defined. This method is problematic in that recommendation based on the statistical method, such as mining, may have a limit in content in which the propensity of a customer reflects the cultural phases of the times in a context where customers and content are continuously expanded and changed.

### DISCLOSURE

### Technical Problem

The present invention has been made in view of the above problems occurring in the prior art, and it is an object of the present invention to provide a method for recommending content with context awareness, which supports a system in which a gathered representative group's preference can be expanded into each personal preference in preference's ontology-based expressions as well as in extraction of the past history-based preference through data mining.

Furthermore, it is another object of the present invention to provide a method for recommending content with context awareness, in which not only preference already defined and classified through ontology-based concept extension and inference, but a frame of continuous concept extension can be provided, and a base model of recommendation can continue to expand.

Furthermore, it is still another object of the present invention to provide a method for recommending content with context awareness, which enables preference extraction through an anonymous personal content service use record without explicit disclosure of personal information.

Furthermore, it is still another object of the present invention to provide an integrated content recommendation method and system, in which it can give recommendation that is more personalized and meets a person's needs by allowing a content recommendation method having an individual characteristic to use a proper recommendation strategy according to a personal context and service context.

### Technical Solution

To achieve the above objects, a method for recommending content with context awareness in accordance with the present invention includes the steps of receiving user information, creating personal preference information based on the user information, deciding a recommendation strategy based on the preference information for content, combining recommendation functions using the recommendation strategy and the content information, personalizing recommendation results with respect to the combination, and providing the personalized content information.

### ADVANTAGEOUS EFFECTS

Thus, the method for recommending content with context awareness according to the present invention can support a system in which a gathered representative group's preference can be expanded into each personal preference in preference's ontology-based expressions as well as in extraction of the past content use history-based preference through data mining.

Furthermore, the present invention can provide a method for recommending content, which can provide not only preference already defined and classified through ontology-based concept extension and inference, but a frame of continuous concept extension and allows a base model for recommendation to continue to expand.

Furthermore, the present invention can provide a method for recommending content, which enables preference extraction through an anonymous personal content service use record without explicit disclosure of personal information.

Furthermore, the present invention can provide an integrated content recommendation method and system, in which it can give recommendation that is more personalized and meets a person's needs by allowing a content recommendation method having an individual characteristic to use a proper recommendation strategy according to a personal context and service context.

Furthermore, the method for recommending content with context awareness according to the present invention has an advantage in that it can offer more efficient and accurate content to mobile terminal users as a mobile communication network is expanded into an IMS basis and opened and therefore the types and number of content accessible by mobile terminals as well as mobile phones increase abruptly.

Furthermore, the method for recommending content with context awareness according to the present invention is advantageous in that it can analogize the life pattern of a mobile terminal user, etc. based on the user's current context information and offers content matching the inferred life pattern at the right time and place.

### DESCRIPTION OF DRAWINGS

FIG. 1 is a schematic diagram showing an intelligence-mixed content recommendation method in accordance with the present invention;

FIG. 2 is a configuration diagram showing a content-based recommendation method in accordance with the present invention;

FIG. 3 is a flowchart showing a content-based recommendation method in accordance with the present invention;

FIG. 4 is a configuration diagram showing an ontology-based recommendation method in accordance with the present invention;

FIG. 5 is a flowchart showing an ontology-based recommendation method in accordance with the present invention;

FIG. 6 is a flowchart showing a process of selecting a recommendation scheme in accordance with the present invention; and

FIG. 7 is a flowchart showing a process of generating a social relation network in accordance with the present invention.

### MODE FOR INVENTION

Detailed description of the above objects, technical configurations, and operational effects of the present invention will be clearly understood from the embodiments of the present invention with reference to the attached drawings.

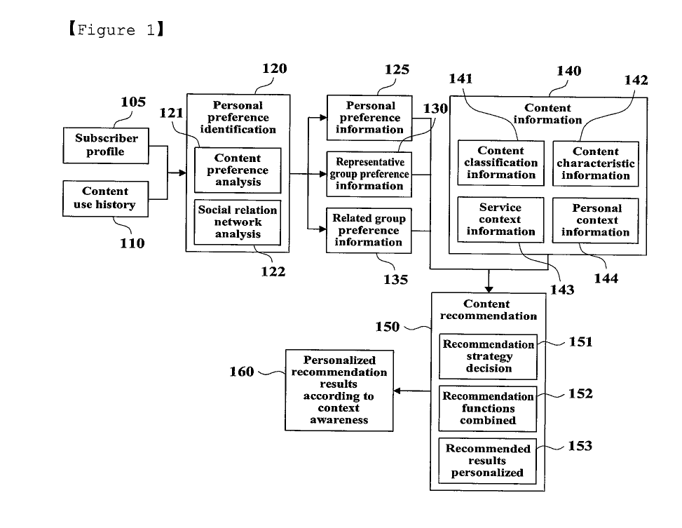

FIG. 1 is a schematic diagram showing an intelligence-mixed content recommendation method in accordance with the present invention. Referring to FIG. 1, personal preference identification information 120 that has received subscriber profile information 105 and content use history information 110 includes content preference analysis 121 and social relation network analysis 122. Three types of preference information, including personal preference information 125 through analysis into the content use history information 110, representative group preference information 130 through data mining analysis into a sample group, and related group preference information 135 analyzed over a social relation network, are identified and extracted from the personal preference identification information 120. The preference information is used according to each service or personal context.

The subscriber profile information 105 is basic information that is input to registration information when a user registers with service. The subscriber profile information 105 comprises a name, a home address, a telephone number, an office address, hobbies, a preferred content type and the like and may further comprise information that can be written by a subscriber in addition to the above list.

The social relation network analysis 122 is used by a subscriber in order to infer other subscribers' social relations who have not directly input the basic information by understanding the subscribers based on static information, i.e., the subscriber profile information 105 and dynamic information in which information about the subscribers' current state is collected. Dynamic information is pieces of information that vary according to time and includes a user's current position, a counterpart caller through the recent telephone call list, a user's current psychological state through analysis of telephone call voice, and so on. For example, subscribers who frequently receive phone calls from a specific subscriber during work time may be inferred as a coworker, a family, a beloved, a work-associated worker, etc. Of the inferred subscribers, a subscriber who uses the same base station from 9 a.m. to 12 p.m., but does not makes a telephone call to another subscriber may be narrowed to a family or beloved. This is because the fact that the subscriber and the corresponding another subscriber are at the same place late at night can be inferred that they exist in the same building.

Furthermore, the representative group preference information 130 is configured by setting a similar user group through a user's profile information, such as a sex, an age, a work, and an area, when the user's content use history or preference content information does not exist, and understanding content preference information corresponding to the set group.

Furthermore, the related group preference information 135 is configured by setting a subscriber group who owns similar profile information to that of a subscriber among one or more subscribers who have been decided through the social relation network analysis 122 and understanding content preference information corresponding to the set group.

Content information 140 transferred from an IMS application service is divided into content classification information 141 and content characteristic information 142 with respect to the contents of content itself and then analyzed. The analysis results are described through a text mining technology and ontology. Furthermore, personal context information 144 and service context information 143 transferred over an IMS network and an application service are described through ontology and used in a process of deciding a recommendation strategy upon recommendation of content. At the time of the content recommendation 150, whether a personal preference exists or not (regarding whether a subscriber is an initial subscriber) and which preference will be used according to the range of recommendation (what a user wants, a similar thing, a thing that can be done by others) are decided in a recommendation strategy decision process 151. A content-based recommendation function and an ontology-based recommendation function or a recommendation function after deciding a mixed use, etc. are combined (152) according to classification and characteristic of content and a degree in which a person and service are reflected in context.

The results recommended as described above are used to decide a priority by reflecting each personal preference and then personalized (153). After the above step, personalized recommendation results 160 according to context awareness are offered to a user.

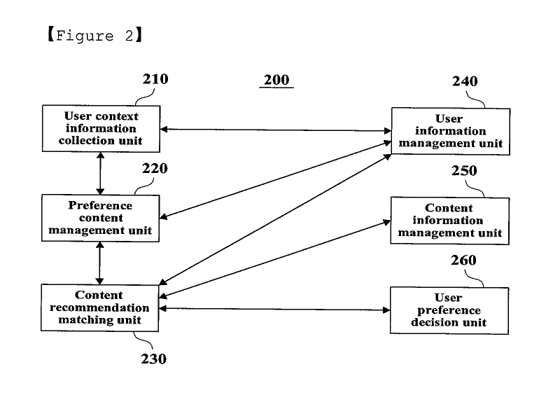

FIG. 2 is a configuration diagram showing a content-based recommendation method in accordance with the present invention. Referring to FIG. 2, a user context information collection unit 210 collects information such as a user's current position, a user's current time, a user's recent call history, a user's psychological state through voice information according to a telephone call, a user's migration path based on information of a base station connected to the user's terminal (the migration path can be collected through a GPS function), and a user's content service history.

A preference content management unit 220 is configured to control intelligent recommendation, decide a recommendation intention of content to be delivered to a user, decide a proper recommendation method and perform a recommendation type search. The preference content management unit 220 choices a recommendation method depending on whether information preferred by a user exists or not and on the basis of context information collected through the user context information collection unit 210.

The preference content management unit 220 receives the user's current context information from the user context information collection unit 210 and requests information of the user from a user information management unit 240. Furthermore, the user context information collection unit 210 may transfer the collected user context information to the user information management unit 240 in order to update the user information.

A content recommendation matching unit 230 is an object that performs contents-based recommendation of content. The contents-based recommendation of content employs a method of identifying statistically meaningful keywords in text constituting content and recommending content on the basis of similarity found using a vector operation based on characteristics (statistical value such as frequency) of a corresponding keyword and characteristics of keywords constituting each user's preference.

The user information management unit 240 stores and manages static information, i.e., profile information, which is input when a user subscribes to a service or additionally input in order to update the information, and dynamic information, i.e., user context information transmitted through the user context information collection unit 210. The user information management unit 240 transmits user information to the preference content management unit 220 at the request of the preference content management unit 220 and also transmits a user's preference content information to the content recommendation matching unit 230 at the request of the content recommendation matching unit 230.

Furthermore, a content information management unit 250 is configured to store and manage content information offered to service subscribers including users. The content information management unit 250 includes, as in FIG. 1, content classification information 141 with respect to stored content, content characteristic information 142, service context information 143, personal context information 144 employing content and so on. Further, the content information management unit 250 provides information about a content model to the content recommendation matching unit 230 at the request of the content recommendation matching unit 230.

A user preference decision unit 260 is an object to govern a personalized ranking (priority decision) of recommended content and can rearrange the arrangement sequence of content that is primarily configured through recommendation according to a personal preference.

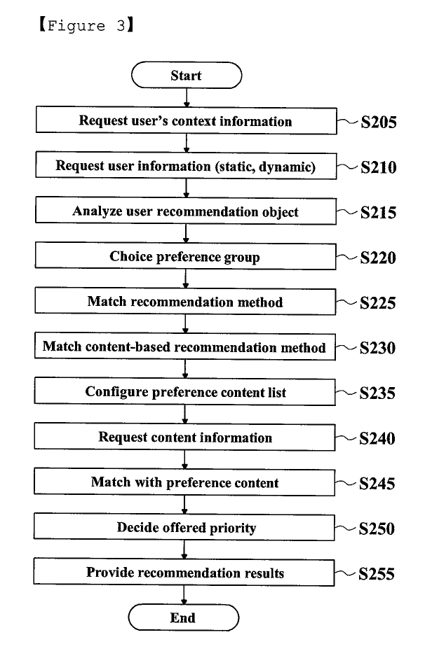

FIG. 3 is a flowchart showing a content-based recommendation method in accordance with the present invention. Referring to FIG. 3 (refer to FIG. 2), the preference content management unit 220 requests a user's context information from the user context information collection unit 210 and receives the user context information therefrom (S205). The preference content management unit 220 requests the user's static information and dynamic information from the user information management unit 240 and receives the static information and dynamic information therefrom (S210).

The preference content management unit 220 that has received the user's context information, static information and dynamic information analyzes a user recommendation object (S215). The preference content management unit 220 then choices a preference group based on the user information (S220). The preference group is selected by identifying three types of preference information, including personal preference information classified according to the user information, preference information of a representative group through data mining analysis into a sample group, and preference information of a related group, which is analyzed through a social relation network.

The preference content management unit 220 matches the analyzed results of the recommendation object to a recommendation method according to the preference group chosen in step S220 (S225). The matched recommendation method is classified into a content-based recommendation method and an ontology-based recommendation method. Here, in the case in which the recommendation method matches the content-based recommendation method (S230), the user's characteristic is compared with a content characteristic, content matching the user is extracted, and a list is configured (S235). Subsequently, the content recommendation matching unit 230 requests the user's preference content information corresponding to the extracted content from the content information management unit 250 and receives the corresponding information therefrom (S240).

The content recommendation matching unit 230 matches the content information, which has been received from the content information management unit 250, and the user's preference information (S245), transmits the matched information to the user preference decision unit 260 so that an offered priority is decided according to a user preference degree (S250).

Next, the content recommendation matching unit 230 provides the user with the recommendation results according to the priority decision result received from the user preference decision unit 260 (S255).

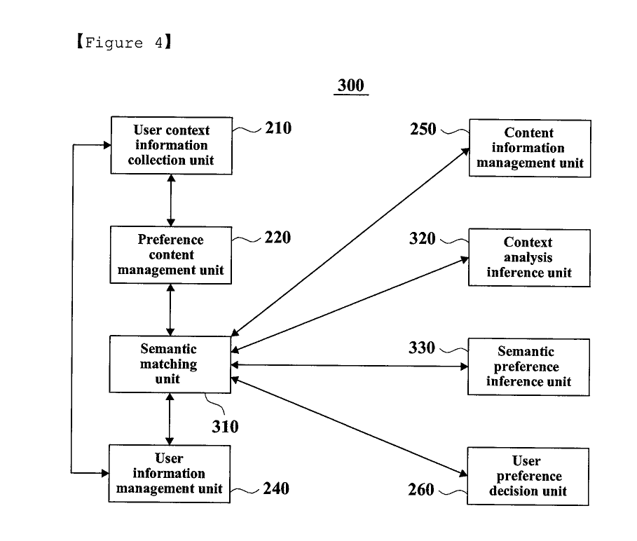

FIG. 4 is a configuration diagram showing an ontology-based recommendation method in accordance with the present invention. Referring to FIG. 4, a user context information collection unit 210 collects information such as a current position, a user's current time, a user's recent call history, a user's psychological state through voice information according to a telephone call, a user's migration path based on information of a base station connected to the user's terminal (the migration path can be collected through a GPS function), and a user's content service history.

A preference content management unit 220 is configured to control intelligent recommendation, decide a recommendation intention of content to be delivered to a user, decide a proper recommendation method and perform a recommendation type search. The preference content management unit 220 choices a recommendation method depending on whether information preferred by a user exists or not and on the basis of context information collected through the user context information collection unit 210.

The preference content management unit 220 receives the user's current context information from the user context information collection unit 210 and requests information of the user from a user information management unit 240. Furthermore, the user context information collection unit 210 may transfer the collected user context information to the user information management unit 240 in order to update the user information.

A semantic matching unit 310 is configured to perform semantic-based recommendation employing ontology and provides an algorithm for measuring a conceptual likelihood ratio in terms of ontology conception between a user's preference mapped to ontology and a content characteristic. Furthermore, the semantic matching unit 310 requests a semantic content model from the content information management unit 250 and requests a user ontology model and a user context model from the user information management unit 240.

The user information management unit 240 stores and manages static information, i.e., profile information, which is input when a user subscribes to a service or additionally input in order to update the information, and dynamic information, i.e., user context information transmitted through the user context information collection unit 210. The user information management unit 240 transmits user information to the preference content management unit 220 at the request of the preference content management unit 220 and also transmits a user's ontology model and a user's context model information to the semantic matching unit 310 at the request of the semantic matching unit 310.

Furthermore, a content information management unit 250 is configured to store and manage content information offered to service subscribers including users. The content information management unit 250 includes, as in FIG. 1, content classification information 141 with respect to stored content, content characteristic information 142, service context information 143, personal context information 144 employing content and so on. Further, the content information management unit 250 provides information about a content model to the content recommendation matching unit 230 at the request of the content recommendation matching unit 230.

A context analysis inference unit 320 is configured to infer a subscriber's context and has a function of inferring conceptual context information based on a subscriber's context information. For example, in the case in which a user's context input through the user context information collection unit 210 is near Samsung-dong Tuesday at 10 a.m. (the user's office address reads Samsung-dong in the user profile information), the context analysis inference unit 320 can infer that the user now works during business hours since it is Tuesday at 10 a.m. and works at the office or near the office since the user is placed near Samsung-dong based on the information.

A semantic preference inference unit 330 is configured to perform rule-based inference by taking a user's context and preference into consideration and guesses a user's context or preference according to a defined hypothesis-based inference rule. For example, the semantic preference inference unit 330 can guess that a corresponding user is a ‘female in her twenties to thirties’ based on the fact that she frequently wears blue jeans and short shirts.

A user preference decision unit 260 is an object to govern a personalized ranking (priority decision) of recommended content and can rearrange the arrangement sequence of content that is primarily configured through recommendation according to a personal preference.

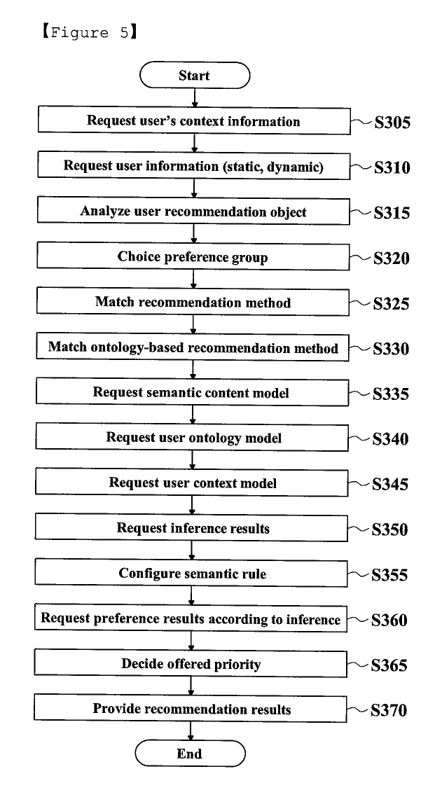

FIG. 5 is a flowchart showing an ontology-based recommendation method in accordance with the present invention. Referring to FIG. 5 (refer to FIG. 4), the preference content management unit 220 requests a user's context information from the user context information collection unit 210 and receives the user context information therefrom (S305). The preference content management unit 220 requests the user's static information and dynamic information from the user information management unit 240 and receives the static information and dynamic information therefrom (S310).

The preference content management unit 220 that has received the user's context information, static information and dynamic information analyzes a user recommendation object (S315). The preference content management unit 220 then choices a preference group based on the user information (S320). The preference group is selected by identifying three types of preference information, including personal preference information classified according to the user information, preference information of a representative group through data mining analysis into a sample group, and preference information of a related group, which is analyzed through a social relation network.

The preference content management unit 220 matches the analyzed results of the recommendation object to a recommendation method according to the preference group chosen in the step S320 (S325). The matched recommendation method is classified into a content-based recommendation method and an ontology-based recommendation method. Here, in the case in which the recommendation method matches the ontology-based recommendation method (S330), the semantic matching unit 310 requests a semantic content model from the content information management unit 250 and receives the semantic content model therefrom (S335). Subsequently, the semantic matching unit 310 requests a user ontology model from the user information management unit 240 and receives the user ontology model therefrom (S340). The semantic matching unit 310 then requests a user context model from the user information management unit 240 and receives the user context model therefrom (S345).

The semantic matching unit 310 transmits the information, received in the steps S335, S340 and S345, to the context analysis inference unit 320, thus requesting inference results about the corresponding information (S350), and receives pertinent information from the context analysis inference unit 320 (S360).

The semantic matching unit 310 that has received the inference results from the context analysis inference unit 320 configures a semantic rule (S355). The semantic matching unit 310 transmits information, including the information received in the steps S335, S340 and S345 and the configured semantic rules, to the semantic preference inference unit 330, thus requesting preference results according to inference, and receives pertinent information from the semantic preference inference unit 330 (S360). Thereafter, the semantic matching unit 310 transmits the received information to the user preference decision unit 260, thus requesting offered priority decision according to a user preference degree (S365). The semantic matching unit 310 provides a user with recommendation results according to a priority decision result received from the user preference decision unit 260 (S370).

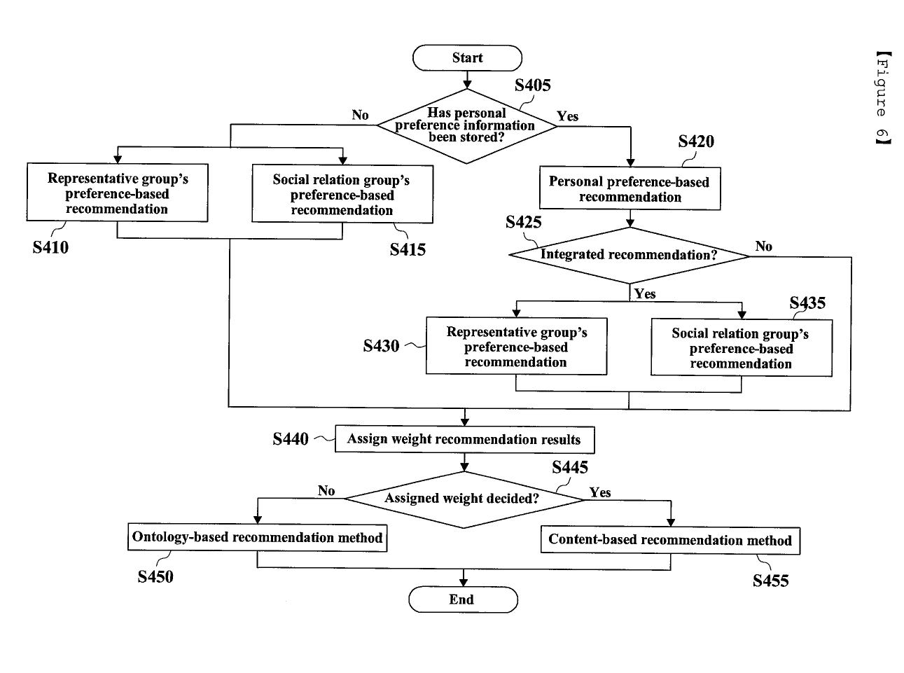

FIG. 6 is a flowchart showing a process of selecting a recommendation scheme in accordance with the present invention. Referring to FIG. 6, it is determined whether a user's personal preference information has been stored (S405). If, as a result of the determination, the user's personal preference information is stored, a personal preference-based recommendation is performed (S420). However, if, as a result of the determination, the user's personal preference information is not stored due to new subscription, etc., preference-based recommendation of a representative group similar to the user's profile is carried out based on the user's profile information, etc. (S410). Further, a social relation group's preference-based recommendation employing preference information of a social relation group to which the corresponding user belongs is performed (S415).

In the case in which the personal preference-based recommendation is performed (S420), it is determined whether integrated recommendation will be given (S425). If, as a result of the determination, the integrated recommendation will be given, a representative group's preference-based recommendation (S430) and a social relation group's preference-based recommendation are further performed (S435). If, as a result of the determination, the integrated recommendation will not be given, the representative group's preference-based recommendation and the social relation group's preference-based recommendation are not carried out.

After the respective preference-based recommendations are performed, weights are assigned to the recommendation results (S440). The assigned weights are then decided (S445). Next, a content-based recommendation method (S450) and an ontology-based recommendation method (S455) are respectively executed according to the decided results.

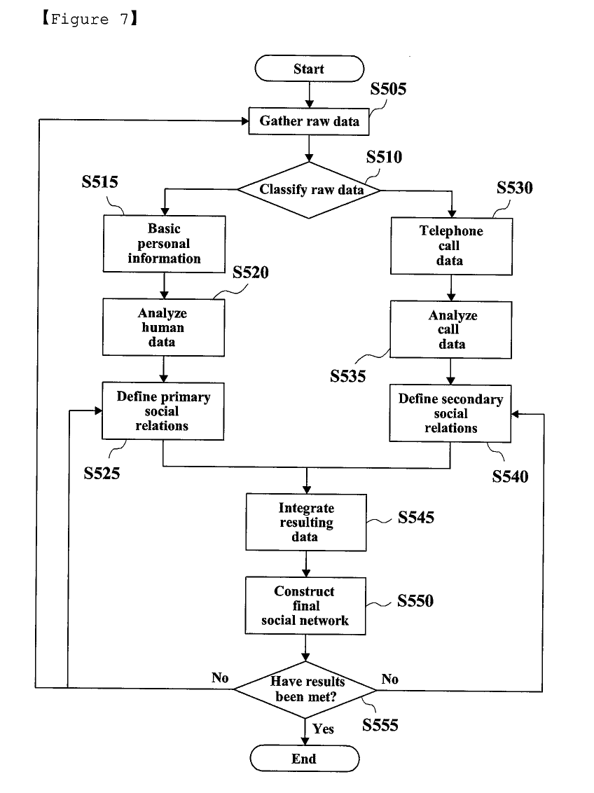

FIG. 7 is a flowchart showing a process of generating a social relation network in accordance with the present invention. Referring to FIG. 7, raw data for creating a user's social relation network is collected (S505). The raw data comprises a user's basic personal information, such as a name, an age, a sex, an address, and a rate system, and a user's call data, such as a call frequency every time band, a call pattern, call counterparts, a call area, and a call time. The raw data for creating the social relation network may further comprise terminal information, etc. in addition to the above data. The collected raw data is classified into basic personal information data and call data (S510).

The classified basic personal information data (S515) is used to extract data for the user's social relation network through human data analysis (S520). That is, an actual user is determined based on registration information (profile information), which has been registered when the user subscribes to a service, and information accumulated according to the user's behavior, and supplementary environment information, the degree of preference, a life pattern, and so on are analyzed and predicted.

Furthermore, the classified telephone call data (S530) is used to analyze information, such as an area where a user is now placed, a user's major call counterparts, and call times and time bands of a user's major calls through call data analysis (S535). For example, in the case of a user who works for a company, information about a social relation network of the user's call counterparts can be extracted by analyzing the user's major call counterparts during office hours or the user's major call counterparts during off-work hours.

Next, the information extracted through human data analysis is defined as primary social relations (S525), and the information extracted through call data analysis is defined as secondary social relations (S540). Data obtained as a result of analyzing the human data and the call data is integrated (S545). A final social network is performed on the resulting integrated data (S550). In the construction of the final social network, data to define the user's final social relation network is extracted depending on whether the data defined in the primary social relation definition step and the secondary social relation definition step is suitable, through analysis of similar data and deletion of the same data and the like. It is then determined whether the data calculated in the final social network construction step is suitable. If, as a result of the determination, the data calculated in the final social network construction step is suitable, the entire steps for creating the corresponding user's social relation network are finished. If, as a result of the determination, the data calculated in the final social network construction step is not appropriate, the results of the corresponding calculated data are determined (S555). The process proceeds to the step of collecting raw data, the primary or secondary social relation definition step according to the determination.

At this time, the determination of the corresponding calculated data can be performed by comparing existing information stored in a social relation network table and the corresponding calculated data in order to understand the degree of similarity. That is, data calculated through a task of creating an existing social relation network is stored in the social relation network table and then compared with social relation network information subsequently calculated. If the resulting value is compatible with a corresponding threshold, the corresponding social relation network information is used. Further, the corresponding social relation network information is stored in an existing social relation network table in order to update the social relation network table.

1. A method for recommending content with context awareness in an IP Multimedia Subsystem (IMS), the method comprising the steps of:
receiving user information;
creating personal preference information based on the user information;
deciding a recommendation strategy based on the preference information for content;
combining recommendation functions using the recommendation strategy and the content information;
personalizing recommendation results with respect to the combination; and
providing the personalized content information.

2. The method as claimed in claim 1, wherein the user information comprises one or more of static information, which is profile information registered when the user subscribes to a service, and dynamic information selected according to the user's current context.

3. The method as claimed in claim 1, wherein the personal preference information comprises one or more of content information preferred by the user, and the user's social relation network information.

4. The method as claimed in claim 1, wherein the recommendation strategy comprises one or more of a content-based recommendation method and an ontology-based recommendation method.

5. The method as claimed in claim 4, wherein the recommendation strategy comprises the steps of:
determining whether the personal preference information has been stored;
selecting a recommendation group according to the decision results;
assigning a weight to a recommended content according to the selected recommendation group; and
selecting one or more of the content-based recommendation method and the ontology-based recommendation method by analyzing the assigned weight.

6. The method as claimed in claim 5, wherein the recommendation group comprises:
a personal preference group including content information preferred by the user;
a representative preference group in which the user's profile information and a similar user group's content information are gathered statistically; and
a social relation group in which content information of one or more second users selected according to the user's social relation network is gathered statistically.

7. The method as claimed in claim 4, wherein the content-based recommendation method comprises the steps of:
creating a content list preferred by the user based on the user information;
collecting content information corresponding to the content list;
matching the collected content information and the content list; and
deciding a priority of the matched results and providing content corresponding to the decided priority.

8. The method as claimed in claim 4, wherein the ontology-based recommendation method comprises the steps of:
collecting semantic content information, user ontology information and user context information;
performing rule-based inference based on the semantic content information, the user ontology information and the user context information;
creating a semantic rule through the rule-based inference;
creating preference results by inferring the semantic rule; and
deciding a priority of the preference results and providing content corresponding to the decided priority.
